(19) United States
(12) Patent Application Publication
(10) Pub. No.: US 2017/0283662 A1
(43) Pub. Date: Oct. 5, 2017

(54) CARTON SEALING TAPE WITH A PLURALITY OF SECURITY FEATURES

(71) Applicant: Intertape Polymer Corp., Sarasota, FL (US)

(72) Inventors: Shawn P. Nelson, Bradenton, FL (US); James Apap Bologna, Sarasota, FL (US); Allison Duffy, Bradenton, FL (US); Jeffrey Scott Coats, Palmetto, FL (US)

(21) Appl. No.: 15/478,993

(22) Filed: Apr. 4, 2017

Related U.S. Application Data
(60) Provisional application No. 62/317,661, filed on Apr. 4, 2016.

(51) Int. Cl. C09J 7/02; B65D 5/42; B65D 55/02; C09J 7/04

(52) U.S. Cl. CPC C09J 7/0267; C09J 7/048; C09J 7/0275; C09J 7/0285; C09J 7/0246; C09J 7/045; B65D 5/4212; B65D 55/02; C09J 2203/338; C09J 2407/00; C09J 2423/101; C09J 2467/001; C09J 2433/00

(57) ABSTRACT

Various carton sealing tapes are disclosed that have a plurality of security features, at least two of which include nanomarker particles having identification indicia visible under about 100 to about 400 times magnification and taggants visible upon exposure to a pre-selected wavelength outside the visible spectrum included in the same or different layers of the tape structure depending upon the selection of the backing material for the substrate of the tape. The carton sealing tapes are also printable for inclusion of a consecutive sequence of coded identification information in the form of a barcode or a 2D code.

### RELATED APPLICATIONS

This application claims the benefit of U.S. Application No. 62/317,661, filed Apr. 4, 2016, incorporated herein by reference in its entirety.

### FIELD OF THE INVENTION

The present invention relates to an adhesive tape, in particular, carton sealing tape with a plurality of security features.

### BACKGROUND OF THE INVENTION

Adhesive tapes are well known in the art. In recent years, attempts have been made to provide carton sealing tapes with features evidencing tampering. However, more reliable, anti-counterfeiting measures are needed for carton sealing tapes.

### SUMMARY OF THE INVENTION

One aspect of the invention is a carton sealing tape having a paper backing that has a major top surface and an opposing major bottom surface, a layer of a water activatable adhesive generally covering the bottom surface of the paper backing, and an ink composition printed on the top surface of the paper backing. The ink composition includes nanomarker particles having identification indicia visible under about 100 to about 400 times magnification, and either the paper backing or the ink composition includes taggants visible upon exposure to a pre-selected wavelength outside the visible spectrum in either the paper backing or the ink composition. The company identification indicia on the nanomarker particles is one or more of a company name, company logo, company trademark, or company phrase, and the taggants are up-shifting phosphorus. The ink composition is printed on the top surface of the tape as a consecutive sequence of coded identification information in the form of a barcode or a 2D code.

In another aspect, carton sealing tape is disclosed that has a backing having a major top surface and an opposing major bottom surface, a layer of an adhesive generally covering the bottom surface of the backing, a clear coat layer generally covering the top surface of the backing, and an ink composition printed on the clear coat layer. At least one of the backing, the clear coat layer, or the ink composition comprises taggants visible upon exposure to a pre-selected wavelength outside the visible spectrum, and when the backing comprises the taggants, the clear coat layer or the ink composition comprises nanomarker particles having company identification indicia visible under about 100 to about 400 times magnification, and when the clear coat layer comprises the taggants, the clear coat layer or the ink composition comprises nanomarker particles having company identification indicia visible under about 100 to about 400 times magnification, and when the ink composition comprises the taggants, the clear coat layer or the ink composition comprises nanomarker particles having company identification indicia visible under about 100 to about 400 times magnification.

In all embodiments, the company identification indicia on the nanomarker particles is one or more of a company name, company logo, company trademark, or company phrase, and the ink composition printed on the clear coat layer comprises a consecutive sequence of coded identification information in the form of a barcode or a 2D code. In one embodiment, the layer of adhesive is a water activatable adhesive, and the backing comprises paper. In another embodiment, the layer of adhesive is a pressure sensitive adhesive and the clear coat layer is a printable release layer.

In another aspect, carton sealing tapes are disclosed that have a polymeric film backing having a major top surface and an opposing major bottom surface, wherein the top surface comprises a material configured to receive an ink composition, a layer of adhesive generally covering the bottom surface of the backing, and taggants visible upon exposure to a pre-selected wavelength outside the visible spectrum and nanomarker particles having company identification indicia visible under about 100 to about 400 times magnification dispersed together throughout the backing or the layer of adhesive, or the taggants in the backing and the nanomarkers in the layer of adhesive, or the nanomarkers in the backing and the taggants in the layer of adhesive.

In one embodiment, the layer of adhesive is a pressure sensitive adhesive and the top surface comprises a printable release layer. Here, the printable release layer may be printed with a consecutive sequence of coded identification information such as a barcode or a 2D code.

In all embodiments, the company identification indicia on the nanomarker particles is one or more of a company name, company logo, company trademark, or company phrase, and the adhesive material in the adhesive layer bonds to fibers in a carton, thereby tearing away a portion of the carton when the tape is peeled from the carton. The backing may further comprise reinforcing elements such as fiberglass or polyethylene terephthalate fibers, and the adhesive material is a natural rubber-styrene-isoprene-styrene blend pressure sensitive adhesive, a water activated adhesive, styrene-isoprene-styrene pressure sensitive adhesive, a natural rubber pressure sensitive adhesive, or an acrylic pressure sensitive adhesive.

One aspect of the invention is a carton sealing tape having a pressure sensitive or water activated adhesive with embedded taggants in the tape backing, whether paper or film, and particles dispersed in the release coating that are visible under magnification of about 100 to about 400 times. The taggants are invisible to the human eye under natural or room lighting, but when a reader emitting a pre-selected wavelength of electromagnetic radiation, for example, an infrared wavelength, is utilized, the fluorescence of the taggants is readable by the reader. The particles dispersed in the release coating are also invisible to the human eye. The particles include a company name, company logo, company trademark, or other indicia identifying the manufacturer of the tape and/or the manufacturer of a product enclosed within the carton, which is sealed by the carton sealing tape. The non-adhesive face of the carton sealing tape is printable in-line with an identification code, such as a barcode or 2D code, with consecutive sequential variations in the identification codes. The identification codes include information such as the origin of the carton and its destination, which provide track and trace capability.

### BRIEF DESCRIPTION OF THE DRAWINGS

FIG. 1 is a perspective view of a roll of carton sealing tape for one embodiment of the invention, which has a water activated adhesive and QR codes printed thereon.

FIG. 2 is an enlarged cross-sectional view of the carton sealing tape of FIG. 1, taken at line 2-2, illustrating the layers thereof.

FIGS. 3A-3C are top, plan views of a section of three different carton sealing tapes, illustrating different examples of identification codes.

FIG. 4 is a photograph of a strip of carton sealing tape applied to a carton and partially peeled away demonstrating the strong bond to the fibers of the carton, some of which peel away with the tape.

FIG. 5 is a photograph of a reader seated on the carton sealing tape on a carton to read the taggants in the backing of the tape.

FIG. 6 is a photograph of a hand held device reading or imaging the identification code.

FIG. 7 is a screen shot from the hand held device showing that the coded information captured according to FIG. 6 has been authenticated.

### DETAILED DESCRIPTION

The following detailed description will illustrate the general principles of the invention, examples of which are additionally illustrated in the accompanying drawings. In the drawings, like reference numbers indicate identical or functionally similar elements.

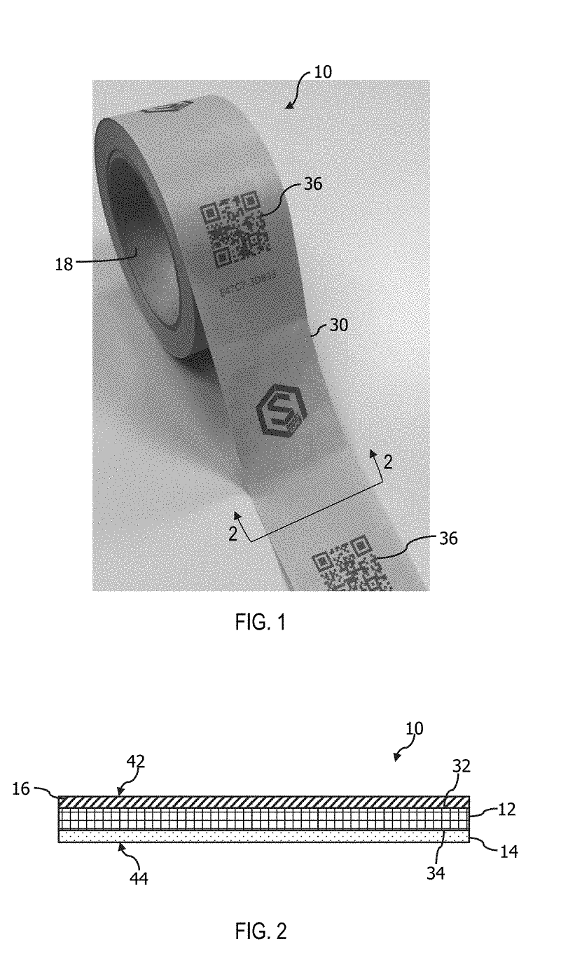

FIG. 1 illustrates a roll 10 of carton sealing tape 30 that has a plurality of security features included therein. The carton sealing tape 30 is wound on a core 18 to form the roll 10. The carton sealing tape 30, as seen in the cross-section of FIG. 2, includes a plurality of layers applied to a tape backing 12 (also referred to as a substrate). The tape backing 12 has a top surface 32 and a bottom surface 34, which define opposing major surfaces of the tape structure. The bottom surface 34 of the tape backing 12 has an adhesive layer 14 applied thereto, and as such defines an adhesive face 40 and functional layer of the tape 30. The top surface 32 of the tape backing 12 has a coating layer 16, which defines a non-adhesive face 42 of the tape 30. The adhesive layer 14 and the coating layer 16 are applied to the tape backing 12 using known techniques at coat weights acceptable for carton sealing tapes. The adhesive layer 14 and the coating layer 16 generally cover the entirety of the respective surface of the tape backing 12. In water-activated tape (WAT) embodiments, the coating layer 16 is clear coat. In pressure sensitive adhesive (PSA) tapes, the coating layer 16 is a printable release layer.

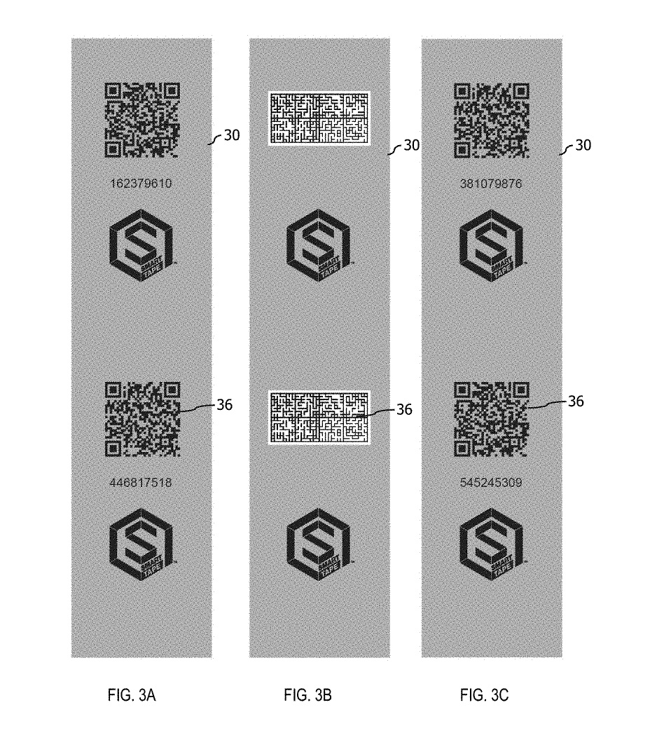

The plurality of security features incorporated into tape 30 include at least two of: (i) an adhesive layer 14 formulated to destroy fibers in the carton when the tape is peeled from the carton; (ii) reinforcement elements in the adhesive tape backing 12; (iii) taggants, especially taggants visible only upon exposure to a pre-selected wavelength outside the visible spectrum; (iv) particles having a company name, logo, trademark, or other indicia identifying a manufacturer of the tape and/or a product enclosed within the carton, which are only visible under about 100 to about 400 times magnification (“nanomarkers”); and (v) an in-line printable non-adhesive face printed with coded information 36 to provide track and trace capability as shown in FIGS. 1 and 3A-3C. In one embodiment, the tape 30 includes at least (iii) and (iv) as the plurality of security features, and often includes (i) and (v) as additional security features. Various combinations of these security features are set forth below in the working examples as well as the options for the location of the taggants and the nanomarkers within the tape structure, which varies depending upon whether the tape is a WAT or a PSA carton sealing tape.

For the carton sealing tape, the tape backing 12 may be a creped paper, synthetic substrate, or other materials known to one of skill in the art as suitable for a backing layer. In one embodiment, the tape backing is a creped paper web, optionally reinforced with fiberglass fibers or polyethylene terephthalate fibers, such as a creped Northern Bleached Softwood Kraft paper. In another embodiment, the tape backing is a clear film backing, which allows the adhesive to be visible therethrough, rendering the adhesive capable of including the taggants and/or the nanomarkers dispersed therein. Example clear film backing includes biaxially oriented polypropylene (BOPP) film, polyethylene terephthalate (PET) film, a polyethylene (PE) film, a film made of a blend of PP and PE.

The security feature of taggants in the tape 30 provides authentication of the tape and the original seal made on a carton by the tape. The taggant may be incorporated in the tape structure as part of the tape backing 12 itself, i.e., included therein during its manufacturing process, or applied thereto by soaking, immersing, coating, and/or dipping the tape backing 12 with/in a solution thereof. When the backing is creped paper, such a Kraft flatback paper, the taggants may be added during the paper making process, in particular in to the paper pulp. When the backing is a film, the taggants may be blended into the molten polymers. For both a paper backing and a film backing, the taggants be dispersed within a coating that applied to the top surface of the backing or within an ink composition that is printed onto the tape.

The taggants are invisible to the human eye under natural or room lighting, but fluoresce when a reader or detector 46 emitting a pre-selected wavelength of electromagnetic radiation, for example, an infrared wavelength or UV wavelength, as shown in FIG. 5 is placed on the tape. The fluorescence of the taggants are readable by the reader 46. The tape 30 having a QR code 36 is applied to a carton 44 and has the detector 46 held against the tape by a user. In one embodiment, the taggants are fluorophores, such as an up-shifting phosphorus material that fluoresce upon exposure to infrared light. In another embodiment, the taggants are radio-wave taggants. The detection system and/or the detector includes a spectrometer, XRF (X-ray fluorescence), or laser detection devices, either tabletop or handheld. The taggants may have an average particle size of less than 25 μm, less than 15 μm, or less than 10 μm.

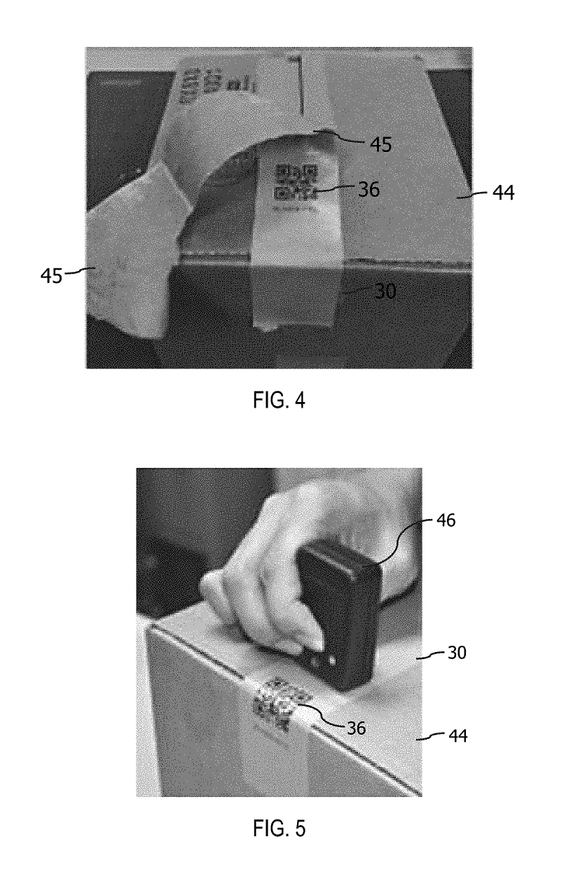

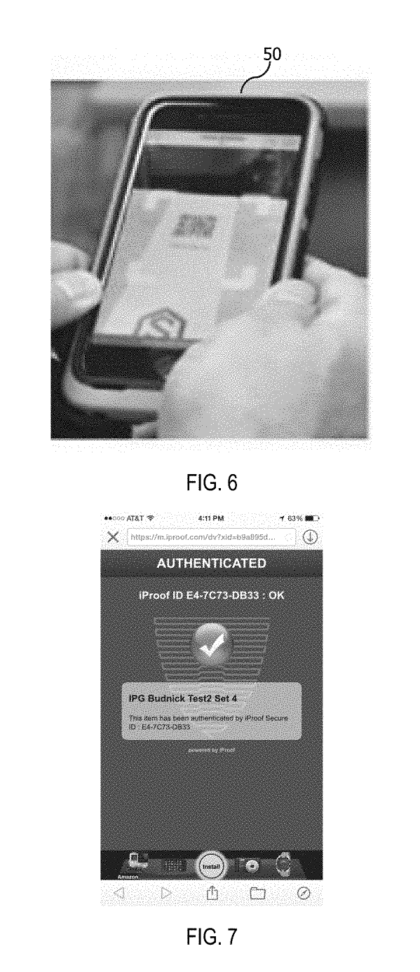

As shown in FIGS. 1-2, the adhesive layer 14 generally covers the bottom surface 34 of tape backing 12 in its entirety. As one of the security features of the tape, the adhesive material in the adhesive layer 14 bonds to fibers in a carton 44, thereby tearing away a portion of the carton 45 when the tape is peeled from the carton 44 as shown in FIG. 4. This makes tampering with a carton evident, as the carton's surface under the tape is marred upon its removal, which is readily visible. The adhesive layer 14 may be applied to tape backing 12 as a solvent-cast, aqueous, solventless, or molten film or as a coating layer using either extrusion, any manner of roll, knife, rod, or blade coating, curtain coating or any other known method. In one embodiment, the adhesive coating layer thickness may range from about 0.1 mil to about 2.5 mil. The adhesive may be a pressure sensitive adhesives (PSA) such as a natural rubber adhesive, a synthetic rubber, or an acrylic, or it may be a water activated adhesive. In one embodiment, the adhesive material is a blend of a natural rubber and a styrene-isoprene-styrene block copolymer (SIS). In another embodiment, the adhesive material is the natural rubber adhesive or the styrene-isoprene-styrene block copolymer (SIS).

As used herein “water activated adhesive,” includes adhesives, or other adhesives that are activated upon the application of a liquid thereto because the adhesive is of a kind that becomes tacky when moistened. The liquid may be water, but is not limited thereto.

The tape 30 optionally includes a coating layer 16, such as a release layer, for example a silicone release coating if the adhesive is a PSA, which allows the tape to be self-winding into rolls or a clear coat layer if the adhesive is a water activated adhesive. The release layer 16 is not limited to a silicone release coating, but may be any other suitable release system known to one of skill in the adhesive and/or tape art so long as it will not obscure detection of the taggants and/or nanomarker when dispersed therein. In one embodiment, a dispersing agent is present in an effective amount to generally uniformly disperse the taggants and/or nanomarkers throughout the release layer.

The non-adhesive face of the carton sealing tape is printable, in particular it is printable in-line with an identification code, such as a barcode or 2D code, with consecutive sequential variations in the identification codes. The identification codes include information such as the origin of the carton and its destination, which provide track and trace capability.

The layers of the tape 30 are simultaneously or sequentially applied to the tape backing 12, in any order, using known techniques.

### WORKING EXAMPLES

TABLE 1
TABLE 1: Tapes comprising taggants in the backing,
nanomarkers in the ink, and an adhesive that destroys
fibers in the carton when peeled therefrom.

| Trial | Backing | Adhesive | Print on the Backing |
|---|---|---|---|
| 1 | Kraft flatback paper | natural rubber/ | printed QR code - |
| | with up-shifting phos- | SIS blend PSA | ink has nanomarkers |
| | phorus taggants | | |
| 2 | Kraft flatback paper | SIS PSA | printed HD barcode - |
| | with up-shifting phos- | | ink has nanomarkers |
| | phorus taggants | | |
| 3 | Kraft flatback paper | water activated | printed 2D barcode - |
| | with up-shifting phos- | adhesive | ink has nanomarkers |
| | phorus taggants | | |
| 4 | Kraft flatback fiber- | water activated | printed QR code - |
| | glass reinforced paper | adhesive | ink has nanomarkers |
| | with up-shifting phos- | | |
| | phorus taggants | | |

TABLE 2
TABLE 2: Tapes comprising taggants in the backing, nanomarkers
in a printable release layer, and an adhesive that destroys
fibers in the carton when peeled therefrom.

| Trial | Backing | Adhesive | Printable release layer |
|---|---|---|---|
| 5 | Kraft flatback - PET | natural rubber/ | nanomarkers with |
| | reinforced paper with | SIS blend PSA | company identifier |
| | up-shifting phosphorus | | dispersed therein; |
| | taggants | | printed with a QR code |
| 6 | Kraft flatback paper | natural rubber/ | nanomarkers with |
| | with up-shifting phos- | SIS blend PSA | company identifier |
| | phorus taggants | | dispersed therein; |
| | | | printed with an HD |
| | | | barcode |
| 7 | Kraft flatback paper | SIS PSA | nanomarkers with |
| | with up-shifting phos- | | company identifier |
| | phorus taggants | | dispersed therein; |
| | | | printed with a 2D |
| | | | barcode |

TABLE 3
TABLE 3: Tapes comprising taggants in the backing, nanomarkers
in a printable coating layer, and an adhesive that destroys
fibers in the carton when peeled therefrom.

| Trial | Backing | Adhesive | Printable Coating Layer |
|---|---|---|---|
| 8 | Kraft flatback paper | water activated | nanomarkers with |
| | with up-shifting phos- | adhesive | company identifier |
| | phorus taggants | | dispersed therein; |
| | | | printed with a QR code |
| 9 | Kraft flatback - fiber- | water activated | nanomarkers with |
| | glass reinforced paper | adhesive | company identifier |
| | with up-shifting phos- | | dispersed therein; |
| | phorus taggants | | printed with a 2D |
| | | | barcode |
| 10 | Kraft flatback - PET | water activated | nanomarkers with |
| | reinforced paper with | adhesive | company identifier |
| | up-shifting phosphorus | | dispersed therein; |
| | taggants | | printed with an HD |
| | | | barcode |

TABLE 4
TABLE 4: Tapes comprising taggants in the backing, nanomarkers
in ink printed on the release layer, and an adhesive that
destroys fibers in the carton when peeled therefrom.

| Trial | Backing | Adhesive | Printable release layer |
|---|---|---|---|
| 11 | BOPP film with up- | natural | printed with a QR code; |
| | shifting phosphorus | rubber PSA | ink has nanomarkers |
| | taggants | | |
| 12 | BOPP film with up- | SIS PSA | printed with an HD code; |
| | shifting phosphorus | | ink has nanomarkers |
| | taggants | | |
| 13 | PET film with up- | natural | printed with a QR code; |
| | shifting phosphorus | rubber PSA | ink has nanomarkers |
| | taggants | | |
| 14 | PET film with up- | SIS PSA | printed with an HD code; |
| | shifting phosphorus | | ink has nanomarkers |
| | taggants | | |

TABLE 5
TABLE 5: Tapes comprising taggants in the backing, nanomarkers
in a printable coating layer, and an adhesive that destroys
fibers in the carton when peeled therefrom.

| Trial | Backing | Adhesive | Printable release layer |
|---|---|---|---|
| 15 | BOPP film with up- | Acrylic | nanomarkers with company |
| | shifting phosphorus | PSA | identifier dispersed therein; |
| | taggants | | printed with a 2D code |
| 16 | PET film with up- | Acrylic | nanomarkers with company |
| | shifting phosphorus | PSA | identifier dispersed therein; |
| | taggants | | printed with a 2D code |

TABLE 6
TABLE 6: Tapes comprising taggants and nanomarkers in
the ink printed on the backing and an adhesive that destroys
fibers in the carton when peeled therefrom.

| Trial | Backing | Adhesive | Print on the Backing |
|---|---|---|---|
| 17 | Kraft flatback | water activated | printed 2D barcode - |
| | paper | adhesive | ink has taggants and |
| | | | nanomarkers |
| 18 | Kraft flatback | water activated | printed QR code - |
| | fiberglass | adhesive | ink has taggants and |
| | reinforced paper | | nanomarkers |

TABLE 7
TABLE 7: Tapes comprising taggants and nanomarkers in the
ink printed on a printable release layer and an adhesive
that destroys fibers in the carton when peeled therefrom.

| Trial | Backing | Adhesive | Printable release layer |
|---|---|---|---|
| 19 | Kraft flatback | natural rubber/ | printed QR code - |
| | paper | SIS blend PSA | ink has taggants and |
| | | | nanomarkers |
| 20 | Kraft flatback | SIS PSA | printed HD barcode - |
| | paper | | ink has taggants and |
| | | | nanomarkers |
| 21 | BOPP film | natural rubber | printed with a QR code; |
| | | PSA | ink has taggants and |
| | | | nanomarkers |
| 22 | BOPP film | SIS PSA | printed with an HD code; |
| | | | ink has taggants and |
| | | | nanomarkers |
| 23 | PET film | natural rubber | printed with a QR code; |
| | | PSA | ink has taggants and |
| | | | nanomarkers |
| 24 | PET film | SIS PSA | printed with an HD code; |
| | | | ink has taggants and |
| | | | nanomarkers |
| 25 | BOPP film | Acrylic PSA | printed with a 2D code; |
| | | | ink has taggants and |
| | | | nanomarkers |
| 26 | PET film | Acrylic PSA | printed with a 2D code; |
| | | | ink has taggants and |
| | | | nanomarkers |

TABLE 8
TABLE 8: Tapes comprising taggants and nanomarkers
in a coating layer and an adhesive that destroys
fibers in the carton when peeled therefrom.

| Trial | Backing | Adhesive | Coating Layer |
|---|---|---|---|
| 27 | Kraft flatback | water activated | has taggants and nanomarkers |
| | paper | adhesive | dispersed therein |
| 28 | Kraft flatback | water activated | has taggants and nanomarkers |
| | fiberglass | adhesive | dispersed therein |
| | reinforced paper | | |

TABLE 9
TABLE 9: Tapes comprising taggants and nanomarkers in a film backing
and a pressure sensitive adhesive and a release layer.

| Trial | Backing | Adhesive | Printable Release Coat |
|---|---|---|---|
| 29 | BOPP film has taggants | PSA | printed with a QR code |
| | and nanomarkers | | |
| 30 | BOPP film has taggants | PSA | printed with an HD code |
| | and nanomarkers | | |
| 31 | BOPP film has taggants | PSA | printed with a 2D code |
| | and nanomarkers | | |
| 32 | PET film has taggants | PSA | printed with a QR code |
| | and nanomarkers | | |
| 33 | PET film has taggants | PSA | printed with an HD code |
| | and nanomarkers | | |
| 34 | PET film has taggants | PSA | printed with a 2D code |
| | and nanomarkers | | |

TABLE 10
TABLE 10: Tapes comprising taggants in a film backing
and a pressure sensitive adhesive having nanomarkers dispersed
therein and a release layer, and vice versa.

| Trial | Backing | Adhesive | Printable Release Coat |
|---|---|---|---|
| 35 | BOPP film has | PSA has nanomarkers | printed with a QR code |
| | taggants | | |
| 36 | BOPP film has | PSA has nanomarkers | printed with an HD code |
| | taggants | | |
| 37 | BOPP film has | PSA has nanomarkers | printed with a 2D code |
| | taggants | | |
| 38 | PET film has | PSA has nanomarkers | printed with a QR code |
| | taggants | | |
| 39 | PET film has | PSA has nanomarkers | printed with an HD code |
| | taggants | | |
| 40 | PET film has | PSA has nanomarkers | printed with a 2D code |
| | taggants | | |
| 41 | BOPP film has | PSA has taggants | printed with a QR code |
| | nanomarkers | | |
| 42 | BOPP film has | PSA has taggants | printed with an HD code |
| | nanomarkers | | |
| 43 | BOPP film has | PSA has taggants | printed with a 2D code |
| | nanomarkers | | |
| 44 | PET film has | PSA has taggants | printed with a QR code |
| | nanomarkers | | |
| 45 | PET film has | PSA has taggants | printed with an HD code |
| | nanomarkers | | |
| 46 | PET film has | PSA has taggants | printed with a 2D code |
| | nanomarkers | | |

TABLE 11
TABLE 11: Tapes comprising a clear film backing and a pressure
sensitive adhesive having taggants and nanomarkers dispersed
therein and a clear release layer, and vice versa.

| Trial | Backing | Adhesive | Printable Release Coat |
|---|---|---|---|
| 47 | BOPP film | PSA has taggants and | printed with a QR code |
| | | nanomarkers | |
| 48 | BOPP film | PSA has taggants and | printed with an HD code |
| | | nanomarkers | |
| 49 | BOPP film | PSA has taggants and | printed with a 2D code |
| | | nanomarkers | |
| 50 | PET film | PSA has taggants and | printed with a QR code |
| | | nanomarkers | |
| 51 | PET film | PSA has taggants and | printed with an HD code |
| | | nanomarkers | |
| 52 | PET film | PSA has taggants and | printed with a 2D code |
| | | nanomarkers | |

Any of the polymeric film backing layers set forth above may include reinforcing elements, including but not limited to fiberglass or polyethylene terephthalate fibers.

The carton sealing tapes disclosed herein provide multiple advantages such as tape authentication from the presence of the taggants, as well as a level of forensic value for validation of product. The printed coded identification information, such as the barcodes or QR codes, provide the ability to embed data on the tape allowing tracking and traceability dependent on a user scanning the code with an electronic device 50, for example a hand held device such as a cell phone or tablet, prior to removing the tape or opening the carton by tearing the tape. The track and trace capability uses software that can read the information stored in the barcode, QR code, or the like, and verify the authenticity of the tape and the data stored in the coded identification information as shown in the screen shot provided as FIG. 7. The particles with company identifier provide covert identification protection for consumers and an additional forensic validation for potential trademark violations depending upon the design of the company identifier on the particles.

Having described the invention in detail and by reference to preferred embodiments, it will be apparent that modifications and variations thereof are possible without departing from the scope of this invention.

What is claimed:

1. A carton sealing tape comprising:
a paper backing having a major top surface and an opposing major bottom surface,
a layer of a water activatable adhesive generally covering the bottom surface of the backing;
an ink composition printed on the top surface of the paper backing, the ink composition comprising nanomarker particles having identification indicia visible under about 100 to about 400 times magnification; and
taggants visible upon exposure to a pre-selected wavelength outside the visible spectrum in either the paper backing or the ink composition.

2. The carton sealing tape of claim 1, wherein the company identification indicia on the nanomarker particles is one or more of a company name, company logo, company trademark, or company phrase.

3. The carton sealing tape of claim 1, wherein the taggants are up-shifting phosphorus.

4. The carton sealing tape of claim 1, wherein ink composition printed on the top surface comprises a consecutive sequence of coded identification information in the form of a barcode or a 2D code.

5. A carton sealing tape comprising:
a backing having a major top surface and an opposing major bottom surface,
a layer of an adhesive generally covering the bottom surface of the backing;
a clear coat layer generally covering the top surface of the backing;
an ink composition printed on the clear coat layer;
wherein at least one of the backing, the clear coat layer, or the ink composition comprises taggants visible upon exposure to a pre-selected wavelength outside the visible spectrum;
wherein when the backing comprises the taggants, the clear coat layer or the ink composition comprises nanomarker particles having company identification indicia visible under about 100 to about 400 times magnification;
wherein when the clear coat layer comprises the taggants, the clear coat layer or the ink composition comprises nanomarker particles having company identification indicia visible under about 100 to about 400 times magnification; and
wherein when the ink composition comprises the taggants, the clear coat layer or the ink composition comprises nanomarker particles having company identification indicia visible under about 100 to about 400 times magnification.

6. The carton sealing tape of claim 5, wherein the company identification indicia on the nanomarker particles is one or more of a company name, company logo, company trademark, or company phrase.

7. The carton sealing tape of claim 5, wherein the layer of adhesive is a water activatable adhesive, and the backing comprises paper.

8. The carton sealing tape of claim 5, wherein the layer of adhesive is a pressure sensitive adhesive and the clear coat layer is a printable release layer.

9. The carton sealing tape of claim 5, wherein ink composition printed on the clear coat layer comprises a consecutive sequence of coded identification information in the form of a barcode or a 2D code.

10. A carton sealing tape comprising:
a polymeric film backing having a major top surface and an opposing major bottom surface, wherein the top surface comprises a material configured to receive an ink composition,
a layer of adhesive generally covering the bottom surface of the backing;
taggants visible upon exposure to a pre-selected wavelength outside the visible spectrum and nanomarker particles having company identification indicia visible under about 100 to about 400 times magnification dispersed together throughout the backing or the layer of adhesive, or the taggants in the backing and the nanomarkers in the layer of adhesive, or the nanomarkers in the backing and the taggants in the layer of adhesive.

11. The carton sealing tape of claim 10, wherein the layer of adhesive is a pressure sensitive adhesive and the top surface comprises a printable release layer.

12. The carton sealing tape of claim 11, wherein the printable release layer is printed with a consecutive sequence of coded identification information.

13. The carton sealing tape of claim 12, wherein the coded identification information is a barcode or a 2D code.

14. The carton sealing tape of claim 10, wherein the company identification indicia on the nanomarker particles is one or more of a company name, company logo, company trademark, or company phrase.

15. The carton sealing tape of claim 10, wherein the adhesive material in the adhesive layer bonds to fibers in a carton, thereby tearing away a portion of the carton when the tape is peeled from the carton.

16. The carton sealing tape of claim 15, wherein the backing further comprises reinforcing elements.

17. The carton sealing tape of claim 16, wherein the reinforcing elements are fiberglass or polyethylene terephthalate fibers.

18. The carton sealing tape of claim 15, wherein the adhesive material is a natural rubber-styrene-isoprene-styrene blend pressure sensitive adhesive, styrene-isoprene-styrene pressure sensitive adhesive, a natural rubber pressure sensitive adhesive, or an acrylic pressure sensitive adhesive.

19. The carton sealing tape of claim 10, wherein the backing comprises a biaxially-oriented polypropylene film or a polyethylene terephthalate film.
